(19) United States
(12) Patent Application Publication
(10) Pub. No.: US 2011/0181399 A1
(43) Pub. Date: Jul. 28, 2011

(54) ENERGY HARVESTING WITH RFID TAGS

(75) Inventors: Richard Stephen Pollack, Boulder, CO (US); Joseph Michael Letkomiller, Thornton, CO (US); Wade W. Webster, Woodinville, WA (US)

(73) Assignee: DVM SYSTEMS, LLC, Greeley, CO (US)

(21) Appl. No.: 13/015,564

(22) Filed: Jan. 27, 2011

Related U.S. Application Data
(60) Provisional application No. 61/299,312, filed on Jan. 28, 2010.
(60) Provisional application No. 61/299,314, filed on Jan. 28, 2010.

(51) Int. Cl. H04Q 5/22

(52) U.S. Cl. 340/10.33; 340/10.1

(57) ABSTRACT

RFID tags, such as those in boluses for ruminant animals, comprise RFID tags may be provided with energy harvesting (EH) capability so that they may collect energy from the environment, either deliberately radiated (such as RF) or gathered from existing sources (i.e., motion, heat, etc.). The energy collected by the RFID tag allows for independent (stand-alone) operation of the tag, such as for logging of temperature in one hour intervals, then transmitting the temperature readings (and ID) periodically (such as six times per day) to a reader (or equivalent, such as an active receiver) using an active RF transmitter (radio) or passive RFID techniques.

### TECHNICAL FIELD

The invention relates to radio-frequency identification (RFID) techniques and also to energy-harvesting (EH) techniques.

### BACKGROUND

Radio-frequency identification (RFID) is a technology that uses communication via radio frequency (RF) waves to exchange data between a “reader” (or “interrogator”) and an electronic RFID “tag” (or “transponder”) which is attached to (or otherwise associated with) an object being monitored (OBM), usually for purposes such as identification and tracking.

RFID tags generally comprise at least two parts:
an integrated circuit (IC) for storing and processing information, modulating and demodulating a radio-frequency (RF) signal and other specialized functions, and
an antenna (ANT) for receiving and transmitting signals, such as from an external reader (or interrogator). Generally, at least the IC portion of the tag may be enclosed in some kind of housing.

Generally, there are three types of RFID tags:
passive RFID tags, which have no power source (no battery) and require an electromagnetic field from an external source (such as the reader) to power the tag electronics and initiate a signal transmission. (In the context of a passive tag, “transmission” may mean modulating an impedance or resonance of an antenna, such as simply shorting or not shorting the antenna, resulting in “backscatter”. These modulations of the antenna can be sensed by the external reader. An antenna may be a coil in a low frequency (LF) magnetic field coupled system or a dipole in an electric field coupled system.) Passive RFID tags can also energize a sensor circuit, when power is being supplied to the tag by the external reader.
active RFID tags, which include a battery (BATT) and a transmitter, and can transmit signals to an external reader. (This is transmission of a signal in the classic sense of the term, and the transmitted signal may be modulated with information.) The tag may make measurements, such as temperature, independently of the reader. The transmissions may occur at periodic intervals, independent of whether there is an external reader nearby (since the reader is not needed to power the active RFID tag), or the tag may transmit in response to a query (request for the tag to transmit) by the external reader.
battery assisted passive (BAP) RFID tags include a battery, but require an external source (such as the reader) to wake up as in a passive RFID tag but have significantly higher forward link capability providing greater range. Since they have a battery, BAP tags can energize a sensing circuit without power being supplied by the reader.

As used herein, a “RFID bolus” may refer to an electronic device comprising an RFID tag and which is suitable for being disposed within an animal, such as within the rumen (the first chamber in the alimentary canal) of ruminant animals such as cattle (cows, or bovines), to monitor a condition of the ruminant animal. Advantageously, an RFID bolus can measure the animal's core temperature, which may provide a critical measure of the animal's health.

An exemplary RFID bolus is manufactured by Phase IV Engineering (Boulder, Colo., www.phaseivengr.com). The Phase IV Engineering Rumen Bolus is a passive RFID transponder which resides in the cow's reticulum, transmitting the animal's temperature and a unique ID number. (A magnet is also provided for collecting metallic objects to prevent hardware disease, but this is not relevant to the operation of the RFID tag.) Temperature and ID are recorded automatically in an attached computer each time the animal walks past a reader (when the tag becomes energized), such as when the cows enter or exit the milking parlor. Obtaining temperature data this frequently (such as 2-3 times daily) enables tracking physiologic cycles and early detection of sickness. The bolus is administered using a standard balling gun.

Some disadvantages or limitations of existing passive RFID tags may include: the tag has no power when it is not near the reader and therefore functions such as measuring temperature (for example in an RFID bolus) can only be performed when passing by a reader. Another limitation of passive RFID tags is that they generally require large readers because of powering limitations of magnetic field coupling which falls off dramatically (1/r³).

Batteries, of course, overcome these inherent limitations of passive RFID tags. However, a limitation of using batteries in an application such as an RFID bolus is that batteries (typically chemical) are not permitted in food animals in many countries, and recovering the batteries (such as for recycling or to keep the battery chemicals out of cattle feed supplies) may also be highly regulated. Another limitation with batteries is that they have a finite life which may be less than then life expectancy of a cow.

As used herein, “energy harvesting” (also known as power harvesting or energy scavenging, or energy gathering) may refer to a process by which electrical energy is derived from external sources (e.g., solar power, thermal energy, wind energy, salinity gradients, and kinetic energy, piezoelectric energy and electromagnetic energy), captured, and stored. Frequently, this term is applied when speaking about small, wireless autonomous devices, like those used in wearable electronics and wireless sensor networks. Some examples of energy harvesting may include:
Kinetic energy harvesting: Some wristwatches (called kinetic watches) are already powered by kinetic energy, in this case movement of an arm. The arm movement causes the magnet in the electromagnetic generator to move. The motion provides a rate of change of flux, which results in some induced emf on the coils.
Piezoelectric energy harvesting: The piezoelectric effect converts mechanical strain into electric current or voltage. This strain can come from many different sources. Human motion, low-frequency seismic vibrations, and acoustic noise are everyday examples. Except in rare instances the piezoelectric effect operates in AC requiring time-varying inputs at mechanical resonance to be efficient.
Electromagnetic (“RF”) energy harvesting: In electromagnetic harvesting, an RF field generated by a transmitter is coupled with a tuned coil or e-field antenna in a receiver.

Kinetic and Piezoelectric energy harvesting are two examples of “mechanical to electrical” (M2E) energy harvesting relying on a mechanical property such as motion or stress to generate voltage (convert mechanical energy to electrical energy). Electromagnetic (or RF) energy harvesting does not rely on motion.

US 2007/0279225, incorporated by reference herein, entitled non-backscatter passive RFID, discloses a radio frequency identification (RFID) system using passive RFID tags that harvest electrical energy from a received signal and store that harvested electrical energy in a capacitor. The stored electrical energy may then be used to transmit from the RFID tag after the received signal has stopped. The RFID tag transmits only briefly, and then uses a subsequent received signal to charge up the capacitor for another brief transmission. In some embodiments, each transmission only represents a single binary bit, but a series of such transmissions may be used to transmit multiple bits.

In US 2007/0279225, although the RFID tag is described as “passive”, it comprises a transmitter (oscillator) to transmit a wireless response in the form of a pulse-width modulated (PWM) radio frequency (RF) signal (rather than, for example, merely modulating the impedance of the antenna coil).

In US 2007/0279225, an RF signal from an external reader may be used to charge up a capacitor in the tag. After the received signal stops, the stored power may be used to transmit a response back to the reader. Generally, the tag alternates charging and transmitting, and the reader alternates transmitting and receiving. This cycle of alternately charging and transmitting by the RFID tag may be repeated as many times as necessary until the RFID tag completes transmitting its entire response.

In US 2007/0279225, the RFID tag (100) may comprise a voltage multiplier (VM) and end-of-burst (EOB) detector (110), a voltage limiter (120)(, a capacitor C_{S}, a voltage sensor (140) to sense the voltage across capacitor C_{S}, control logic circuit (150), an oscillator (160) producing a carrier wave, an amplifier (170), and an antenna (180). The capacitor is capable of storing enough electrical charge to power the RFID tag circuit long enough for the RFID tag circuit to transmit a signal representing at least one binary bit.

The following patents and publications are incorporated by reference herein
U.S. Pat. No. 6,369,712—Response adjustable temperature sensor for transponder
U.S. Pat. No. 6,412,977—Method for measuring temperature with an integrated circuit device
U.S. Pat. No. 6,486,776—RF transponder . . . measuring parameters associated with a monitored object

### SUMMARY

It is a general object of the invention to provide an improved RFID bolus, such as for ruminant animals.

It is a general object of the invention to provide improved techniques for operating RFID tags with energy harvesting.

A plurality of objects being monitored (OBMs) may be disposed in an environment, each having its own RFID tag. The RFID tag may be able to transmit a unique identification (ID) number for its OBM to a reader, and may also be provided with sensors so that it can measure, store and transmit information to the reader.

Generally, the RFID tag is provided with energy harvesting (EH) capability so that it may collect energy from the environment, either deliberately radiated (such as RF) or gathered from existing sources (i.e., motion, heat, etc.). The energy collected by the RFID tag allows for independent (stand-alone) operation of the tag, such as for logging of temperature periodically, such as in one hour intervals (which may be referred to herein as “continuously”), then transmitting a the temperature readings (and ID) periodically (such as one to six times per day) to a reader (or equivalent) using an RF transmitter in the bolus.

A feature of various embodiments disclosed herein, particularly the RF energy harvesting embodiments, is that the RFID tag can run off (operate from) its stored energy and make several periodic measurements (such as temperature) in an interim time between periodic transmissions of data. Measuring is typically done several times more often than transmitting. In other words, the ratio of measuring to transmitting need not be 1:1 (as in 2007/0279225). Rather, the ratio of measuring to transmitting may be at least 2:1, such as 3:1, 4:1, 5:1 or more. Stated otherwise, the measuring intervals may be much shorter than the transmitting intervals.

For electromagnetic energy harvesting, a number of intentional radiators (sources of RF energy to be harvested) which are RF “exciters” (or “energizer/energizing units/sources”) may be disposed throughout the environment at strategic locations to ensure that a cow is in proximity with an energizing unit for a sufficient period of time to gather sufficient energy for operation. For example, 1 minute of energy harvesting may provide sufficient energy to enable the bolus to take one temperature measurement per hour for 6 hours or more.

The energy harvesting bolus may comprise an active RFID tag (with transmitter), and
In a first option, the bolus may harvest energy from the motion of the rumen. This is referred to as “mechanical to electrical” (M2E) energy harvesting (EH).
In a second option, energy may be harvested from an RF signal purposely transmitted to the bolus from “Energizing Units” located where animals are known to congregate. (An Energizing Unit may be a “dumbed down” reader or interrogator, its primary purpose being to propagate an electromagnetic field for energy harvesting by RFID tags in boluses, data transmission or collection being an optional or secondary feature.)

In both options, harvested energy may enable powering microcontroller and sensor circuits in the bolus that measure temperature or other parameters (such as pH, pressure or the motion of the animal) at periodic intervals, for example, approximately once per hour. The data from these measurements may be stored in memory of the RFID tag until it is practical to power its active transmitter or passive backscatter technique that transmits to a receiver (reader), which may be approximately a few times per day.

In the second (RF) option, the system is designed so that
although only a few minutes per day may be spent harvesting energy (when the cow is near an energizing unit),
enough power is harvested by the tag in those few minutes to enable it to collect sensor measurements several times per day (such as once per hour), and
the tag may transmit its data “open loop” several times per day, or only when it is in the vicinity of a reader.
Usage of energy collected by the tag and stored in its energy storage capacitor may thus be optimized.

The energy harvesting bolus may comprise a passive RFID tag. In a passive RFID bolus embodiment, a bolus with an energy harvesting unit (EHU) may eliminate some disadvantages of passive RFID boluses. A disadvantage of a passive system without energy harvesting is that no power is available except when the bolus is near a reader, and therefore sensor measurements can only be made when the animal passes by (in range of) a reader. By using harvested energy stored in a bolus, sensor readings may be taken at any time and stored in memory for later transmission when the animal passes by an RFID reader. Also, the read range in the current art passive RFID systems is limited because sole source of energy for the passive RFID tag is RFID energy provided by the reader to power the bolus circuits. By using stored energy from energy harvesting, the power supplied by the reader can be “assisted”, increasing the reading distance such as by a factor of two or more.

Some aspects and features of the invention may include (but are not limited to):
optimizing power use versus power gathering, such as by regulating temperature measurement to once per hour
utilizing a ultra-low power temperature sensing circuit and memory
optimizing energy usage by the RFID tag to transmit about 10 feet through a cow, such as at the UHF frequency range of 315-433 MHz
gathering energy from a low frequency source via a ferrite rod in the bolus, and rectifying the gathered energy to charge a storage capacitor
sizing the RFID tag, including energy harvesting element(s) fit within a bolus
determining appropriate energizing units, power levels and locations (in the monitored environment), charge time, energizing unit antenna sizes and distances that would combine to create enough energy (capacitor charge) to meet energy budgets

Other objects, features and advantages of the invention may become apparent in light of the following description(s) thereof.

### BRIEF DESCRIPTION OF THE DRAWINGS

The structure, operation, and advantages of the present preferred embodiment of the invention will become further apparent upon consideration of the descriptions set forth herein, taken in conjunction with the accompanying figures (FIGs). The figures (FIGs) are intended to be illustrative, not limiting. Although the invention is generally described in the context of these preferred embodiments, it should be understood that it is not intended to limit the scope of the invention to these particular embodiments.

In any diagrams such as block diagrams or schematic diagrams showing electronic components, connections between the components may only be shown generally and may not be explicitly described. However, one having ordinary skill in the art should understand how the components are connected, based on the presentation in the diagrams.

FIG. 1 is a diagram illustrating an environment having a number of objects being monitored (OBMs), these objects having mechanical-to-electrical (M2E) energy harvesting (EH) RFID tags, according to an embodiment of the invention.

FIG. 2 is a diagram illustrating an embodiment of the invention.

FIG. 3 is a diagram illustrating an embodiment of the invention.

FIG. 4 is a diagram illustrating an embodiment of the invention.

FIG. 5 is a diagram illustrating an embodiment of the invention.

FIG. 6 is a diagram illustrating an embodiment of the invention.

FIG. 7 is a diagram illustrating an embodiment of the invention.

FIG. 8 is a diagram illustrating an embodiment of the invention.

### DETAILED DESCRIPTION

Various “embodiments” of the invention (or inventions) will be described. An embodiment may be an example or implementation of one or more aspects of the invention(s). Although various features of the invention(s) may be described in the context of a single embodiment, the features may also be provided separately or in any suitable combination. Conversely, although the invention(s) may be described herein in the context of separate embodiments for clarity, the invention(s) may also be implemented in a single embodiment.

In the main hereinafter, energy harvesting RFID tags are described in the context of RFID boluses which:
are provided with energy harvesting (EH) capability,
are disposed in the rumen of ruminating animals such as cows, in the monitored environment of a dairy farm, or other places where animals are kept,
are capable of periodically (sometimes referred to as “continuously”, usually meaning independently, at brief intervals such as once per hour) monitoring and storing information related to a condition such as animal core temperature, and
periodically (such as every six hours) transmitting the cow's ID and stored temperature information to a reader.

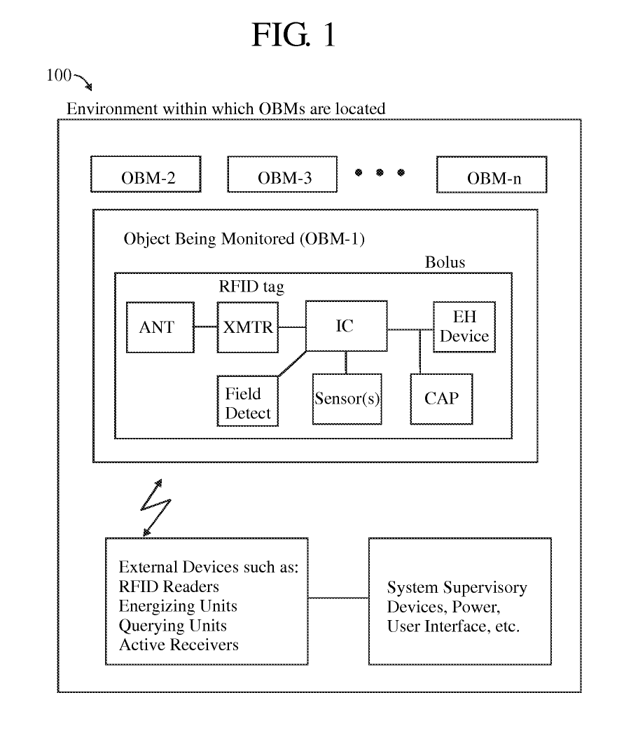

FIG. 1 shows a plurality of (n) OBMs, labeled OBM-1, OBM-2, OBM-3 . . . OBM-n are located in a monitored environment. The OBMs may be cows, and the monitored environment may be a dairy farm. One OBM (OBM-1) is shown in some detail, as representative of all of the OBMs (OBM-1 . . . OBM-n). A bolus is disposed within the rumen of OBM-1.

An RFID tag may be disposed within the bolus. In various embodiments disclosed herein, the RFID tag may comprise various combinations of the following,
circuitry (labeled “IC”) which may comprise a microcontroller and associated circuitry,
sensors,
a transmitter (or “radio”, lableled XMTR), and
a field detection circuit
an antenna (ANT).
an Energy Harvesting (EH) device (and associated power control circuitry)
an energy storage device (“CAP”), such as a capacitor (other means for storing electrical energy harvested from the EH device, such as a supercap and a non-chemical battery may be employed)

The EH device may be a device for converting mechanical to electrical energy, or for harvesting electromagnetic (RF) energy.

External Devices may be provided such as various combinations of
an RFID reader for interrogating the RFID tag
Energizing Units for supplying electromagnetic (RF) energy to be harvested by the RFID tag
Inquiry Sources (Querying units) for waking up the RFID tag
Receivers for receiving data from the RFID tag

System Supervisory Devices may be provided for controlling the operation of the External Devices, monitoring and managing data collected from the RFID tags, and the like.

The RFID tags, External Devices and System Supervisory Devices described above are exemplary of an overall “RFID system”.

Various embodiments of RFID tags and Energy Harvesting (EH) devices will be described, hereinbelow. First, there follows a discussion of two illustrative types of energy harvesting devices—mechanical-to-electrical (M2E) and radio frequency (RF)—that may be used in conjunction with the various embodiments of RFID tags disclosed herein. It is within the scope of the invention that other types of energy harvesting devices may also be employed.

Mechanical-to-Electrical (M2E) Energy Harvesting

It is known by ruminant animal experts that the rumen is in constant motion. This motion is caused both by ruminal contractions to flush material through the rumen and by regurgitation of the cud. It is known that the contractions occur every 1 to 3 minutes. The M2E embodiments described herein capitalize on this motion to create a source of power for the internal circuitry.

A mechanical-to-electrical (M2E) energy harvesting (EH) device may be disposed in the bolus and associated with the tag. When the rumen moves, energy will be generated. This energy may be stored in a storage capacitor (or the like), and be sufficient to enable periodic (such as once per hour) monitoring of sensor data (such as core temperature) and periodic (such as a few times per day) transmission of the tag's ID and stored data to an external RFID reader.

An RFID reader may be fixed at a location in the environment, such as at an entry to a milking parlor, or a watering trough. When the OBM is in close proximity with (such as within 10 feet of) the reader, the RFID tag can detect the presence of the reader (from the RF interrogating field emanating from the reader) and in response thereto transmit its data (ID and sensor data) to the reader.

A mechanical-to-electrical energy harvesting unit may be optimized to the specific motion of the rumen during contractions and regurgitation to generate an electrical voltage and current which is used to charge a capacitor or “supercap” or a non-chemical battery such as those made by Infinite Power Solutions (for example Thinergy MEC120 Solid-State, Rechargeable, Thin-Film Micro-Energy Cell, the specification of which is incorporated by reference herein). All of these storage medium may be referred to herein simply as “storage capacitor” (or simply “capacitor”, when talking about energy storage).

The electrical energy stored in the storage capacitor may be adequate to power a circuit, for example a microcontroller attached to a temperature sensor, to take temperature readings periodically at regular intervals throughout the day (which may be referred to as “continuously” in that these readings may be taken independent of an energizing source), for example once per hour, and store readings in memory.

The harvested energy may also be adequate to power an active transmitter that transmits the data stored in memory several times per day. The radio may operate in the LF, HF or the UHF band. Transmitting in the UHF band may permit greater reception range than the LF or HF typically used in passive RFID systems. A mechanical-to-electrical (M2E) energy harvesting (EH) unit may comprise an electromagnetic or piezoelectric device, for example

An Electromagnetic Generator

An electromagnetic EH device may comprise a magnet and a coil, at least one of which is moving, relative to the other (typically the coil will be the moving element). An electric current is generated by moving a coil through the magnetic field of a fixed magnet, thereby converting mechanical energy (movement) into electrical energy. This current is rectified into a DC source that is used to charge a capacitor or solid state battery. The magnet for the current generator may also serve as the magnet commonly placed in cows for hardware disease. When the magnet attracts metal ingested by the animal around the bolus the magnet may be constrained by the magnetic attraction to the metal and may not be able to freely move. Therefore, the design may have a fixed (relatively stationary) magnet and the rumen motion may cause the coil to move with respect to the magnet. The coil may be weighted with a mass (to cause it to oscillate or spin when the bolus is moved by the rumen).

The energy generating mechanism (energy harvesting unit) may be optimized for the type of motion in the rumen. Since the amount of energy generated is a function of the speed of the coil cutting the magnetic field lines, the moving coil may be attached to the springs with the proper tension and spring constant to cause the coil to oscillate quickly whenever the bolus moves. This may magnify the slow speed of the rumen motion so that the coil moves through the magnetic field with higher speed. To eliminate the failure mode of the connection wires breaking due to flexing, the springs that are attached to the coil may serve as the electrical contact for the coil. One end of each spring may be connected to a coil lead and the other to the voltage out terminals of the energy harvesting unit.

An example of an electromagnetic M2E EH device is the Ferro VEH-460, the specification of which is incorporated by reference herein.

Another example of an electromagnetic M2E EH device is described in the publication: “Development of an Electro-Magnetic Transducer for Energy Harvesting of Kinetic Energy and its' Applicability to a MEMS-scale Device”, incorporated by reference herein.

Alternately, a geared pendulum mechanism may spin a coil past the magnet at high speed. A technique like this is used in the Seiko Kinetic watch, and is incorporated by reference herein.

A Piezo-Electric Generator.

A piezo-electric generator device converts mechanical energy such as the flexing of a piezo-electric member into an electric charge (electrical energy).

An example of a piezoelectric M2E EH device is the Noliac 7779, the specification of which is incorporated by reference herein.

An example of a piezoelectric M2E EH device is piezo-electric film, such as that manufactured by Advanced Cerametrics (Harvester-III power module), the specification of which is incorporated by reference herein.

An example of a piezoelectric M2E EH device is piezo-electric film, such as the Midi Corporation V22BL Piezo Electric Raw Energy Harvester, the specification of which is incorporated by reference herein.

The piezoelectric M2E EH device may be optimized (such as to be resonant) for the type of motion in the rumen. Since the amount of energy generated is a function of frequency and amplitude of the vibration of the piezo-electric film, the piezo-electric member may comprise a mass at the end of a cantilever beam where the material property, size and mass may be selected to create mechanical resonance that may optimize the energy generated from the particular type of motion that occurs in the rumen.

For an example of a chip for converting piezoelectric output to a usable voltage, see, for example “Practical Design Considerations for Piezoelectric Energy Harvesting Applications”, Linear Technology Corporation, 2010.

As will become evident, some of the operating conditions of the various embodiments of energy harvesting (EH) RFID tags described herein may be common to both M2E energy harvesting (described above) as well as electromagnetic (or RF) energy harvesting (described below). Some differences will also become evident. The techniques described herein may also be useful in the context of other types of energy harvesting, such as heat, chemical, etc.

Radio Frequency (RF) Energy Harvesting

Generally, this method utilizes an antenna (either a separate antenna or the antenna already in the tag) in the bolus to gather radio frequency energy transmitted by an external intentional radiator, such as an energizing (or energizer) unit (or source).

An energizing unit may generate low frequency RF (such as 19 KHz or 134.2 KHz) energy which is not attenuated by tissue to such a great degree as higher frequencies (such as 434 MHz) are. This RF energy will be harvested by the RFID tag, and stored in the energy storage capacitor (or similar).

Generally, a simple cost effective coil wound ferrite rod antenna (which may be, but need not be separate from the tag antenna) in the RFID tag may be used to efficiently collect this energy. This energy is then rectified and stored (in a capacitor or the like) to provide power for operation of the RFID tag without requiring that the RFID tag be in range of the intentional radiator (energizing source).

A number of energizing units having field generating antennas may be strategically located throughout the environment within which OBMs are located (being monitored) can be used to provide this energy source. This system would also be compatible with existing passive systems.

The energy received by the bolus may be used to charge a storage capacitor (including supercap) or solid state battery and this stored energy can be used to power circuitry to independently (without being in the presence of the intentional radiator) enable taking temperature or other sensor readings periodically (such as at regular intervals) and storing them in memory.

The stored data may be transferred to receivers in the environment using an active transmitter (XMTR, or radio) within the RFID tag. The transmissions may occur at regular intervals (periodically), such as a few times per day. Or, the transmissions may occur in response to the filed from an energizing unit being is detected.

Alternately, since the resonant tuned circuit use for energy gathering may comprise essentially a passive RFID antenna, the data may be transmitted to an RFID reader using conventional passive RFID techniques, whereby the data are communicated to the Reader by loading the bolus tuned circuit which is detected via the mutual inductance between the Reader LC circuit doing the energizing and the bolus LC circuit.

The following features (options) may be relevant to RF energy harvesting:

Energy source: Electromagnetic field generators (“Energizing Units”) may be placed at various strategic locations such as the entries to milking parlors, near water troughs and elsewhere where animals congregate. These units may provide the energy that is harvested by the bolus. A handheld reader may also be used as an Energizing Unit. These Energizing Units may use a low frequency (LF) of 134.2 kilohertz as specified by ISO standards for animal identification. The Energizing Unit may be a conventional high power RFID reader.

The Energizing Units may modulate the energizing signal to enable sending data to the bolus in addition to sending power. In such a case, the RFID tag would have a receiver (RCVR), and optionally an additional antenna for the receiver. This “write feature” may enable the bolus to be updated with data, such as history of sickness, treatment, change of ownership, etc., which would be stored in non-volatile memory. The data writing operation of the Energizing Unit may also be used to send an acknowledgement (ACK) to the RFID tag to let it know that its transmission was received.

Energy collection by the bolus: Boluses may comprise an inductive-capacitive (LC) circuit, resonant tuned to the frequency of the Energizing Unit. For maximum energy collection capacity, the LC circuit in the bolus may comprise a sizeable ferrite core wound with a large diameter wire. The received energy may be rectified to a DC voltage which may charge a capacitor, possibly a supercap or a solid state battery. The energy stored in the capacitor from one incidence of the animal being near the Energizing Unit may transfer enough energy to a capacitor to power a low-power microcontroller and measurement circuit for at least several hours.

The microcontroller may wake up upon a programmed interval, for example once per hour, measure temperature, and store the data in memory. In this embodiment enough Energizing Units may be placed in a dairy to ensure that animals are in the proximity often enough and for adequate time to ensure that the energy received is sufficient to keep the capacitor charged.

Generally, the coupling of power by RF transmission (from the energizing unit to the RFID tag) is an inefficient process, requiring for example, up to 20 watts to be transmitted by the energizing unit in order for tens of milliwatts to be received by and stored in the RFID tag.

One or more RFID reader (or interrogator) units may be disposed at various locations throughout the environment to communicate with and collect data from the various RFID tags, and although these reader units may be used simply to “wake up” the RFID tag, they may also be used to power the tag. (The RFID readers may also be used to power “legacy” RFID tags, such as described hereinabove.)

### Block Diagram Descriptions of Some Embodiments

Active Transmitter, Transmit on a Fixed Interval

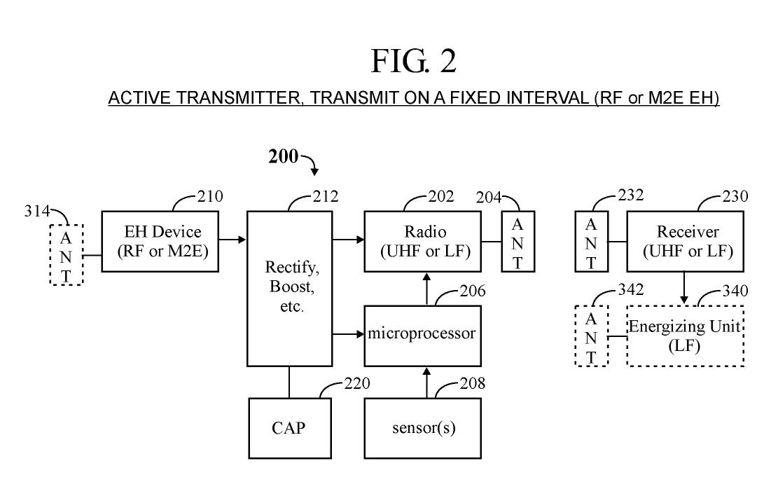

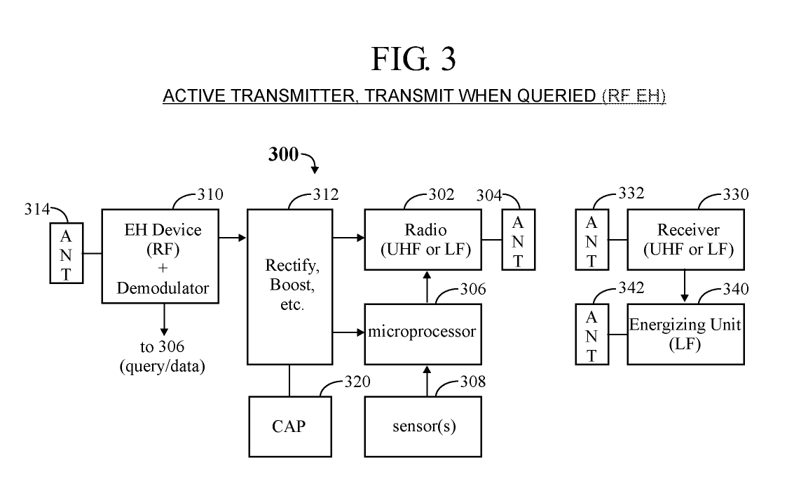

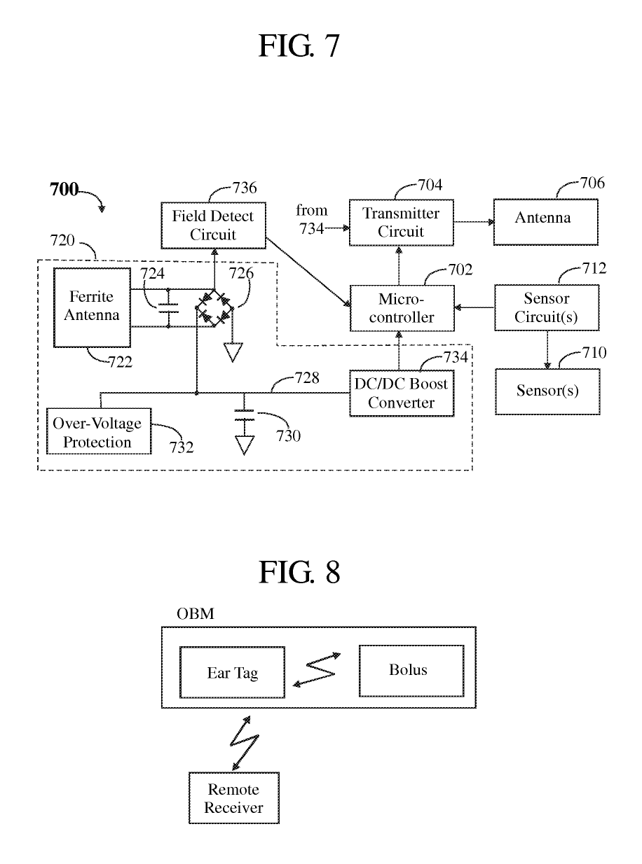

FIG. 2 illustrates an embodiment of an RFID tag 200 comprising
a radio (active transmitter) 202 and associated antenna 204 for transmitting data (such as tag ID and sensor measurements). The radio may be UHF (such as 315-434 MHz) or LF (such as 125 KHz or 134 KHz).
a microprocessor (or microcontroller) 206, which may include its own real time clock and memory
sensors 208 for temperature or other conditions, and associated sensor circuitry (not separately illustrated)
an energy harvesting (EH) device 210, which may be a radio frequency (RF) or mechanical-to-electrical (M2E) device, such as has been described hereinabove
   if the energy harvesting device is RF, a separate energizing unit (340) and antenna (342) such as shown in FIG. 3 would be included, as well as an antenna coil (314) for the EH Device 210. These options are shown generally in dashed lines in FIG. 2, and are described in greater detail hereinbelow with respect to FIG. 3. A feature of this FIG. 2 embodiment being emphasized is that the tag transmits on its own, independently of being queried by an energizing unit (as described in FIG. 3). And, if RF energy harvesting were used in this embodiment (as in FIG. 3), the tag could still transmit on its own.
circuitry 212 associated with the EH device 210 for voltage rectification, boost, overvoltage protection and for charging of an energy storage capacitor 220 (or the like, such as a supercap, or a thin-film (non chemical) battery). The circuitry 212, and similar circuitry (312, 412, 512, 612) in other embodiments disclosed herein may be implemented with a Linear Technology Corp LTC3108 or LTC3588, the specifications of which are incorporated by reference herein, or the like.
   the LTC3588 Piezoelectric Energy Harvesting Power Supply is designed for a piezo (M2E) input and rectifies the output which is typically at a higher voltage.
   The LTC3108 Power management chip is designed to operate on very low voltages, manage a storage capacitor and regulate its output with minimal power. The LTC3108 doesn't rectify, it just boosts a very low voltage DC input, and would be used LTC3108 for the RF and electromagnetic versions which have very low voltage outputs. Rectification, as shown in FIG. 7 (726) would be added. The Maxim 1724, the specification of which is incorporated by reference herein, provides essentially the same function as the LTC3108.

A receiver 230 (which may be referred to as “active receiver” since it is a receiver for receiving transmissions from the radio of an “active” RFID tag) is provided within the environment for receiving transmissions (such as tag ID and sensor measurements) from the RFIG tag 200. The receiver 230 has an antenna 232 associated therewith, and is exemplary of a plurality of receivers which may be distributed throughout the environment.

The microprocessor and clock 206 may cause data to be transmitted by the tag at fixed intervals, a few times (for example 3-6 times) per day. This would be a programmable interval. Measurements and storage of sensor data may also occur periodically, many times (for example every hour, such as 24 times) per day.

In this embodiment, the RFID tag 200 transmits “blindly”, and when the transmission is being made, the RFID tag (which is in the cow) could be anywhere in the environment when the transmission occurs, and may not be in range of the receiver 230. It may therefore be desirable to transmit the data in a highly redundant manner, for example, all of the temperature measurements for the last (preceding) 24 hours may be transmitted every time (such as 3-6 times per day) that the RFID tag transmits. (Implicit in this scheme is that data older than 24 hours would be shifted out of memory, if memory size is a constrain.) Each datum (such as each of the many temperature measurements made during the day) would be stamped with the time at which the measurement was made. Of course, this is likely to result in a lot of redundant data being collected, but such redundant data could be deleted by a “smart” receiver 230, or at the system supervisory level (FIG. 1).

Active Transmitter Transmit when Queried (RF EH)

In the previous embodiment, date-stamping collected data and redundant transmission were described as a way of circumventing a situation when data is transmitted by the RFID tag, periodically, and the tag may not be in range of a receiver. In this embodiment, the RFID tag only transmits when queried.

Many similarities may be noted between this embodiment (FIG. 3) and the previously-described embodiment (FIG. 2). Many of the elements may be identical, and may be numbered similarly (for example, element 202 may be identical with element 302).

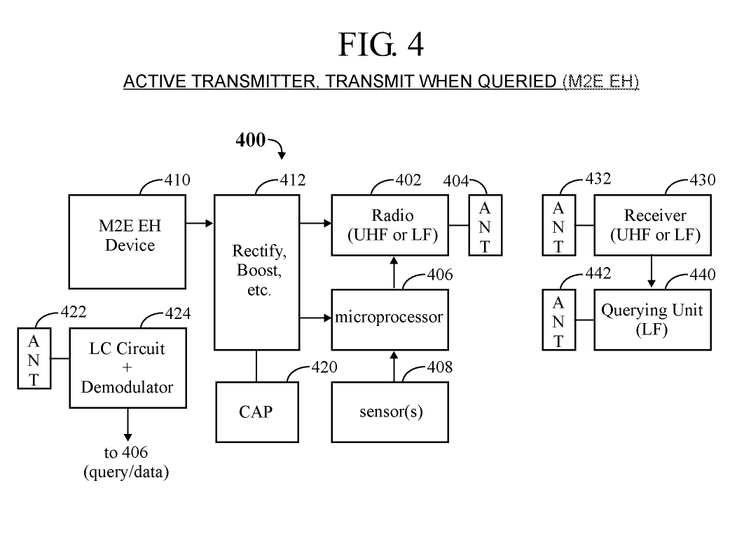

This embodiment (FIG. 3) describes a version of RFID tag with radio frequency (RF) energy harvesting (EH). The next embodiment (FIG. 4) describes a version of RFID tag with mechanical-to-electrical (M2E) energy harvesting.

FIG. 3 illustrates an embodiment of an RFID tag 300 comprising
a radio (active transmitter) 302 and associated antenna 304 for transmitting data (such as tag ID and sensor measurements). The radio may be UHF 315-434 MHz, or may be LF such as 125 KHz or 134 KHz.
a microprocessor (or microcontroller) 306, which may include its own real time clock and memory
sensors 308 for temperature or other conditions, and associated sensor circuitry (not separately illustrated)
an energy harvesting (EH) device 310, which may be a radio frequency (RF) energy harvesting device, such as has been described hereinabove. The device 310 may include its own antenna 314 for receiving power and/or data from an external energizing unit 340 (described below), and may also include a detector/demodulator for alerting the microprocessor 306 that the RFID tag 300 is within range of the external energizing unit 340 (described below) and providing the microprocessor with data which may be contained in the signal propagated by the energizing unit 340 (described below)
circuitry 312 associated with the EH device 310 for voltage rectification, boost, overvoltage protection and for charging of an energy storage capacitor 320 (or the like, such as a supercap, or a thin-film (non chemical) battery)

A receiver 330 (which may be referred to as “active receiver” since it is a receiver for receiving transmissions from the radio of an “active” RFID tag) is provided within the environment for receiving transmissions (such as tag ID and sensor measurements) from the RFID tag 300. The receiver 330 has an antenna 332 associated therewith, and is exemplary of a plurality of receivers which may be distributed throughout the environment.

An energizing unit (EU) 340, which may have its own antenna 342 is provided in the environment, and may operate at low frequency (LF), such as 19 KHz 125 KHz or 134 KHz. The energizing unit may receive data from the receiver 330, and may modulate information onto the signal that it transmits (broadcasts). The receiver 330 and energizing unit 340 may be physically located in close proximity with one another. The energizing units disclosed herein for RF energy harvesting can be “on” all the time.

In this embodiment, the RFID tag 300 transmits in response to being queried. Querying may be implemented by the Energizing unit broadcasting a low frequency (such as 19 KHz 125 KHz or 134 KHz) RF signal which, in addition to providing the energy for energy harvesting, can also be detected by the RFID tag 300 to alert the tag that it is in range of the active receiver 330, whereupon it transmits data (such as ID, sensor measurements) stored in its memory. Upon receiving an ACK that the data has been received, the tag may delete old sensor data.

The RF EH device 310 may also include a demodulator to extract data modulated on the energy harvesting signal from the Energizing Unit 340 (which may transmit both power and data), and provide the query “notice” and data (such as the aforementioned ACK signal) to the microprocessor 306 of the RFID tag 300.

The receiver 330 may be located near the energizing unit 340. Since the RFID tag 300 only transmits when queried (when within range of the energizing unit), this essentially guarantees that the receiver 330 is in range of the RFID tag when the RFID tag 300 is transmitting. Since the typical query range will be shorter than the typical receiving range, this ensures that the receiver 330 is in short range of the transmission by the RFID tag 300. This short range facilitates a lower power active transmitter (radio 302) to be used, which lowers the demand for the amount of energy that needs to be harvested by the RFID tag 300.

To enhance data integrity, the Energizing Unit 340 and Active Receiver 330 may be connected/communicate with one another. In this way the Receiver 330 can send a signal (ACK) to the Energizing Unit 340 indicating it has received a valid transmission (such as via CRC error checking), or that it did not receive a valid transmission. The Energizing Unit 340 can then send data to the RFID tag 300 by modulating (such as by ASK modulation) the signal that it broadcasts. If the RFID tag receives a communication via the modulated energy signal from the Energizing Unit 340 that valid data was not received (NAK) by the receiver 330, the microprocessor 306 could cause the data to be resent via the active transmitter (radio) 302 until an ACK was received.

Active Transmitter Transmit when Queried (M2E EH Version)

This embodiment (FIG. 4) describes a version of RFID tag with mechanical-to-electrical (M2E) energy harvesting (EH), and has many elements that may be identical with elements of the previously-described (FIG. 3) RF energy harvesting, transmit when queried embodiment.

FIG. 4 illustrates an embodiment of an RFID tag 400 comprising
a radio (active transmitter) 402 and associated antenna 404 for transmitting data (such as tag ID and sensor measurements). The radio may be UHF 315-434 MHz, or may be LF such as 125 KHz or 134 KHz.
a microprocessor (or microcontroller) 406, which may include its own real time clock and memory
sensors 408 for temperature or other conditions, and associated sensor circuitry (not separately illustrated)
an energy harvesting (EH) device 410, which may be a mechanical-to-electrical (M2E) energy harvesting device, such as has been described hereinabove.
an LC coil (antenna) 422 (which may be incorporated with or separate from the antenna 404) and associated detector/demodulator circuitry 424 for alerting the microprocessor 406 that the RFID tag 400 is in proximity with the querying unit 440 (described below). This Low Frequency Query function is essentially the same as for the previous RF Energy Harvesting Active system (FIG. 3) except that the separate LC coil and circuit needs to be added to the RFID tag 400 to receive the query signal, since this does not already exist as part of the energy harvesting circuit. Also, separate Querying Units would need to be deployed with each Receiver to cause the tag to transmit when in range.
   The detector/demodulator 424 alerts the microprocessor 406 that the RFID tag 400 is within range of the active receiver 430 (described below) and providing the microprocessor 406 with data which may be contained in the signal propagated by the querying unit 442 (described below).
circuitry 412 associated with the EH device 410 for voltage rectification, boost, overvoltage protection and for charging of an energy storage capacitor 420 (or the like, such as a supercap, or a thin-film (non chemical) battery)

A receiver 430 (which may be referred to as “active receiver” since it is a receiver for receiving transmissions from the radio of an “active” RFID tag) is provided within the environment for receiving transmissions (such as tag ID and sensor measurements) from the RFIG tag 400. The receiver 430 has an antenna 432 associated therewith, and is exemplary of a plurality of receivers which may be distributed throughout the environment.

A Querying Unit (QU) 440, which may have its own antenna 442 is provided in the environment with each Receiver, and may operate at low frequency (LF), such as 19 KHz 125 KHz or 134 KHz. The Querying Unit may receive data from the receiver 430, and may modulate information onto the signal that it transmits (broadcasts). The receiver 430 and querying unit 440 may be physically located in close proximity with one another.

In this embodiment, the RFID tag 400 detects the LF “query” signal from the Querying Unit 440, and transmits in response to being queried. Querying may be implemented by the Querying unit broadcasting a low frequency (such as 19 KHz 125 KHz or 134 KHz) RF signal, much in the same manner in which the energizing unit 340 of the previously-described FIG. 3 embodiment, which can be detected by the RFID tag 400 to alert the tag that it is in range of the active receiver 430, whereupon it transmits data (such as ID, sensor measurements) stored in its memory. Upon receiving an ACK that the data has been received, the tag may delete old sensor data.

The receiver 430 may be located near the querying unit 440—much in the same manner in which the energizing unit 340 of the previously-described FIG. 3 embodiment. Since the RFID tag 400 only transmits when queried (when within range of the energizing unit), this essentially guarantees that the receiver 430 is in range of the RFID tag when the RFID tag 400 is transmitting. Since the typical query range will be shorter than the typical receiving range, this ensures that the receiver 430 is in short range of the transmission by the RFID tag 400.

To enhance data integrity, the Querying Unit 440 and Active Receiver 430 may be connected/communicate with one another—much in the same manner in which the energizing unit 340 of the previously-described FIG. 3 embodiment. In this way the Receiver 430 can send a signal (ACK) to the Energizing Unit 440 indicating it has received a valid transmission (such as via CRC error checking), or that it did not receive a valid transmission. The Querying Unit 440 can then send data to the RFID tag 400 by modulating (such as by ASK modulation) the signal that it broadcasts. If the RFID tag receives a communication via the modulated energy signal from the Querying Unit 440 that valid data was not received (NAK) by the receiver 430, the microprocessor 406 could cause the data to be resent via the active transmitter (radio) 402 until an ACK was received.

The demodulator of 424 extracts data modulated on the querying signal (with data) from the querying unit 440 and provides the query “notice” and data (such as the aforementioned ACK signal) to the microprocessor 406 of the RFID tag 400.

Passive (Backscatter) Communication (RF EH)

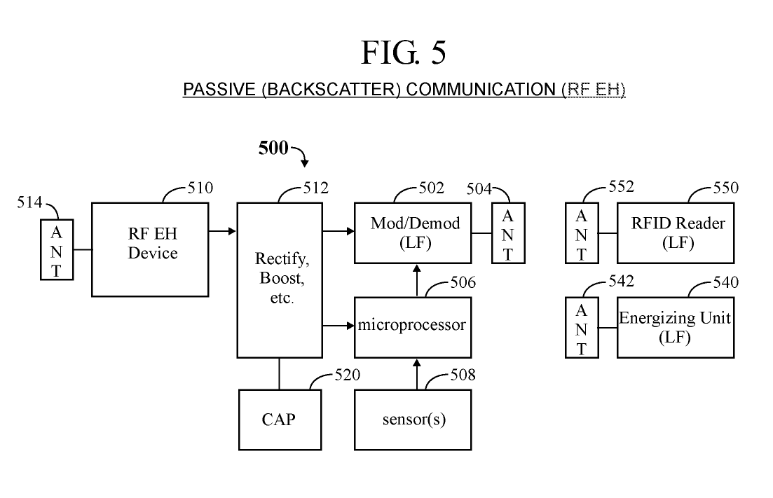

This embodiment (FIG. 5) describes a version of RFID tag with radio frequency (RF) energy harvesting (EH), and has a few elements that may be identical with elements of the previously-described embodiments. Communication between the tag and an external reader (or interrogator) is via backscatter (using a passive RFID protocol), and is not “transmission” in the active sense of the word. (The previously described embodiments shown in FIGS. 2, 3 and 4 all used transmission by radios.)

FIG. 5 illustrates an embodiment of an RFID tag 500 comprising
a modulator/demodulator circuit 502 and associated antenna 504 which may emulate an RFID modulation scheme such as ISO 11785.
a microprocessor (or microcontroller) 506, which may include its own real time clock and memory
sensors 508 for temperature or other conditions, and associated sensor circuitry (not separately illustrated)
an energy harvesting (EH) device 510, which may be a radio frequency (RF) energy harvesting device, such as has been described hereinabove. The device 510 may include its own antenna 514 for receiving power and/or data from an external energizing unit 530 (described below) which may be part of or separate from an RFID reader 550 (described below)
circuitry 512 associated with the EH device 510 for voltage rectification, boost, overvoltage protection and for charging of an energy storage capacitor 520 (or the like, such as a supercap, or a thin-film (non chemical) battery)

An RFID reader 550 having an antenna 552 associated therewith may operate at low frequency (LF), such as 125 or 134 KHz to communicate with the RFID tag 500, in a conventional passive RFID manner. A plurality of RFID readers may be distributed throughout the environment.

An energizing unit (EU) 540 which may have its own antenna 542 is provided in the environment, and may operate at low frequency (LF), such as 125 KHz or 134 KHz. The energizing unit 540 may be incorporated into the reader 550, or may be separate. Generally, there is no need in this embodiment for the signal from the energizing unit 540 to be modulated to send information to (communicate with) the RFID tag, because the reader 550 has that functionality built-in. The RFID reader 550 and energizing unit 540 may be physically located in close proximity with one another.

The RFID Reader 550 and Energizing Unit 540 may be combined into a single unit. And, there may be additional Energizing Units for energy harvesting that are not Readers, which may enable more energy harvesting between data transfer.

When the RFID tag 500 is near enough to the Reader 550 to communicate, the Reader 550 may cause stored sensor data and ID number in the RFID tag to be transmitted by the tag to the reader in a conventional manner (the same as in prior art passive RFID tags). This may be done with standard RFID techniques and it includes possibility that the Reader 550 can write data to the tag 500 as in Read/Write Tag. See, for example, U.S. Pat. Nos. 6,369,712 and 6,412,977 (note that the tags described in these patents are read-only tags), incorporated by reference herein. (Unlike prior art tags where the modulator/demodulator circuit, sensor circuit and memory functions are typically incorporated into a single ASIC, in this case these functions may be performed by a microprocessor and separate modulator/demodulator circuit.)

A benefit of an energy harvesting approach is that the range between the reader 550 and the tag 500 during reading may be increased due to the fact that the reader not being required to generate the voltage instantaneously during reading since the capacitor 520 may already be charged with previously harvested energy. Developing this voltage may benefit from the cow (OBM) staying in the coupling field of the reader 550 longer than for a typical RFID transaction, or be in the field of other energizing units 540 prior to being read by the Reader 550.

A single antenna (or “tag coil”) may be used both for energy harvesting (542) and for the RFID reading (552) by requiring the Reader to have a modulated command that indicates it is a reader and not an energizing unit. Suitable ferrite core tag coil antennas are described herein.

Passive Backscatter Communication (M2E EH)

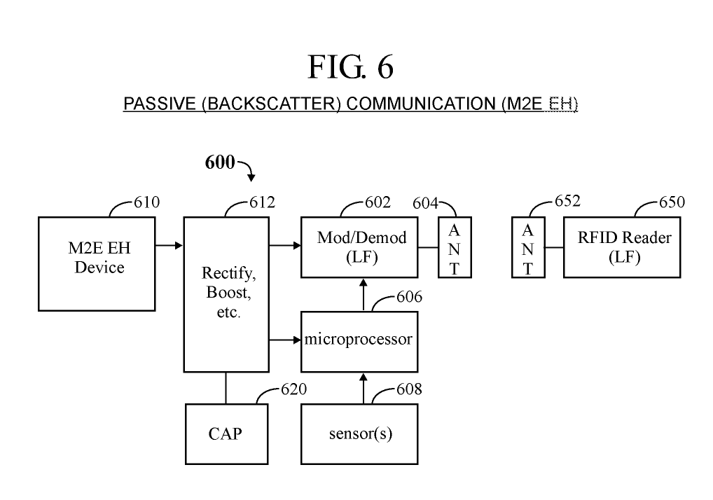

This embodiment (FIG. 6) describes a version of RFID tag with mechanical-to-electrical (M2E) energy harvesting (EH), and has many elements that may be identical with elements of the previously-described embodiments, particularly with the embodiment of FIG. 5.

FIG. 6 illustrates an embodiment of an RFID tag 600 comprising
a modulator/demodulator circuit 602 and associated antenna 604 (tag coil) which may emulate an RFID modulation scheme such as ISO 11785.
a microprocessor (or microcontroller) 606, which may include its own real time clock and memory
sensors 608 for temperature or other conditions, and associated sensor circuitry (not separately illustrated)
an energy harvesting (EH) device 610, which may be a mechanical-to-electrical (M2E) energy harvesting device, such as has been described hereinabove.
circuitry 612 associated with the EH device 610 for voltage rectification, boost, overvoltage protection and for charging of an energy storage capacitor 620 (or the like, such as a supercap, or a thin-film (non chemical) battery)

An RFID reader 650 having an antenna 652 associated therewith may operate at low frequency (LF) to communicate with the RFID tag 600, in a conventional manner. A plurality of RFID readers may be distributed throughout the environment.

When the RFID tag 600 is near enough to the Reader 650 to communicate, the Reader 650 may cause stored sensor data and ID number in the RFID tag to be transmitted by the tag to the reader in a conventional manner (the same as in prior art passive RFID tags). This may be done with standard RFID techniques and it includes possibility that the Reader 660 can write data to the tag 600 as in Read/Write Tag. See, for example, U.S. Pat. Nos. 6,369,712 and 6,412,977, (note that the tags described in these patents are read-only tags), incorporated by reference herein. (Unlike prior art tags where the modulator/demodulator circuit, sensor circuit and memory functions are typically incorporated into a single ASIC, in this case these functions may be performed by a microprocessor and separate modulator/demodulator circuit.)

A benefit of an energy harvesting approach is that the range between the reader 650 and the tag 600 during reading may be increased due to the fact that the reader not being required to generate the voltage instantaneously during reading since the capacitor 620 may already be charged with previously harvested M2E energy.

When the RFID tag 600 is near enough to the Reader 650 to communicate, the Reader 650 may causes stored data and ID number of the tag to be transmitted to the reader in the same manner as prior art RFID tags, with standard RFID techniques, and may include the possibility that the Reader 650 can write data to the tag 600.

In some embodiments disclosed herein, the M2E energy harvesting device (such as 610) may incorporate its own rectifying, boost and storage circuitry (such as 612).

### Further Description of an Active RFID Tag Embodiment

FIG. 7 is a block diagram of an Energy Harvesting Bolus 700. The Bolus comprises an active RFID tag comprising a microprocessor (microcontroller) 702, transmitter circuit 704 and an antenna loop 706. The microcontroller 702 may include memory (such as 8 KB, generally, not much memory is needed), or external memory (not shown) may be provided. A suitable microcontroller 702 may be a Microchip PIC18FxxK20 which includes memory, the specification of which is incorporated by reference herein.

Various sensors 710 may be provided, such as for sensing temperature. (Of particular interest is core temperature of the cow). A separate interface circuit 712 for the sensor(s) may be provided, if suitable circuitry is not internal to the microcontroller. Temperature measurements may be stored in the memory of the microcontroller (or external memory). The ADT7310 digital temperature sensor, the specification of which is incorporated by reference herein, may be employed here for the sensor 710 and circuit 712.

An RF energy harvesting device, including power management, is shown in the dashed line 720.

A ferrite-core antenna 722 and a tuning capacitor 724 form a tuned (LC) circuit. The antenna may be tuned to a given frequency, such as 134.2 KHz (ISO standard for animal RFID) and converts magnetic fields at this frequency to a usable alternating current (ac) voltage. A typical ac voltage from the antenna 722 may be 20 vac.

The ac voltage is rectified, such as by a bridge rectifier 726 and provided as a direct current (DC) voltage on a line 728 to an energy storage capacitor 730 The DC voltage may be less than 1 vdc. The energy storage capacitor 730 may have a rating of 0.2 farad, and stores energy to operate the RFID tag, as described below.

An over-voltage protection circuit 732 may be connected to the line 728 to assure that in strong fields (from the energizing unit), the energy storage capacitor 730 is not operated beyond its limits, and excessive charge may be dissipated. A suitable over-voltage protection circuit is ZRC330 Precision 3.3 voltage low knee current voltage reference, the specification of which is incorporated by reference herein. This circuit 732 may be similar to the voltage limiter 120 in US 7007/0279225.

A DC/DC boost converter 734 is connected to the energy storage capacitor 730 and may provide a steady DC voltage output, such as 2.7 vdc for operating the microcontroller 702. A suitable boost converter is the Max 1724 (from Maxim), the specification of which is incorporated by reference herein. The boost converter may be similar to the multiplier (110) in US 2007/0279225.

A field detect circuit 736 (which may or may not be considered to be one of the energy harvesting components, per se) detects a signal from the ferrite-loop antenna 722 and wakes the microcontroller 702 when the storage capacitor 730 is being charged by a field.

In response to the signal from the field detect circuit 736 the microcontroller 702 may transmit its stored data.

The approach used here is generally to use stored energy to measure temperature periodically and put it into memory. Then, when either queried by a reader to let the bolus know it is near a local receiver (which may be the reader), or in another approach just upon some interval, the bolus will use the stored energy to transmit to local receivers (which may be “simplified” versions of the readers, not requiring a transmit function).

A low power consumption timer (in the microcontroller) may provide the microcontroller 702 with a wake up interval for recording temperature sensed by the Temperature Sense Circuit 712. The microcontroller 702 will thus power up only intermittently to record the temperature at the programmed rate to save power. The recorded data is stored in the microcontroller's memory.

Some typical power requirements (consumption) for the EH bolus may be:

| | | |
|---|---|---|
| Sleep current (Microcontroller asleep Dc/Dc converter on) | 2.6 | μA |
| Temperature Sensor conversion (Microcontroller on Sensor | 840 | μA |
| circuit on) | | |
| Write to Memory (Microcontroller on) | 800 | μA |
| Transmit Cycle (Microcontroller and transmitter on) | 1,840 | μA |

Using the percentage of “on time” in each of the categories based on a temperature storage rate of 1 temperature measurement per hour, a 6 hour logging time and two transmissions (per day) of the 6 stored temperatures, the average current may be 2.677 μA. (The time spent in sleep mode is 99.991% of the total at one sensor reading/hour.)

The ESR (Load) of the Storage capacitor 730 may be in the 100-200 ohm range depending on manufacturer. For best power transfer, the ferrite Antenna impedance should be closely matched.

The microcontroller 702 may wake up upon a programmed interval, for example once per hour, to measure temperature (and/or other conditions such as motion, pressure, pH, etc.), and store the reading(s) in memory. These sensor reading(s) may be associated with the time and date from a real-time clock circuit.

Some exemplary parameters for the ferrite core antenna 222 may be:
L=200 uH
Turns=65
Tuning Capacitor=390 pF
Resonant frequency=135 kHz
Wire type=24 gauge solderable
Ferrite type: 77
Ferrite size: 0.375-0.5″ diameter×2.5-3.2″″ long
Impedance (XL) @ 134.2 KHz=168.6 ohm

The circuit components described herein may be packaged to fit in a bolus. A typical bolus may be generally cylindrical, having a diameter of 0.8″ and a length of 3.6″. It may be desirable to fit a magnet (for hardware disease) in the same bolus. It is also important that a bolus have a certain specific gravity, for example greater than 3.0, to optimize retention in the reticulum after insertion in the cow. The bolus size, ferrite size, wire diameter, magnet size and other components may be selected to achieve this density without adding separate weighting material. See, for example Phase IV Ruminant Animal ID and Temperature Monitoring Technology and Products, the specification of which is incorporated by reference herein. (A magnet may also be provided in the bolus for collecting metallic objects to prevent hardware disease, but this is not relevant to the operation of the RFID tag.)

In a manner similar to the RF energy harvesting embodiment, a M2E embodiment of the EH RFID tag 700 may include:
a kinetic or piezoelectric transducer generating an ac voltage
means for rectifying the ac voltage (compare 726)
an energy storage capacitor (compare 730)
over-voltage protection (compare 732)
a DC/DC boost converter (compare 734)
a field detect circuit (compare 736) would not be needed in the case of the tag transmitting on a fixed interval (such as described in FIG. 2), but would be included in the case of the tag transmitting in response to being queried (such as described in FIG. 4) so that it would transmit when near a receiver.

US 2007/0279225, generally harvests only sufficient energy for essentially one transmission, which may only be one (or a few) bits). The energy is harvested from a reader, and the information is transmitted immediately to the reader. The reader stops emitting a signal when the tag is transmitting. In the RF energy harvesting embodiments disclosed herein, there is no need for the intentional radiator (such as energizing unit 340 in FIG. 3, or reader 550 in FIG. 5) to stop radiating, it can continue uninterrupted to provide the energy harvesting.

In the EH RFID tag disclosed herein, sufficient energy is harvested to operate the RFID tag for a significant period of time (e.g., one day of operation, collecting data periodically such as once per hour and transmitting several bits of information, periodically, such as every few hours). Moreover, the RFID tag can transmit, using the energy stored in the storage capacitor, to transmit data without any energizing source (or reader) being nearby, and the energizing sources can be left on all the time. In the EH RFID tag disclosed herein, it is possible to:
collect data without any energizing source nearby
transmit without an energizing source nearby
collecting/storing data once per hour, transmitting it once per every few hours

US 2007/0279225 discloses that the reader shuts off to listen for the tag as part of the concept. In contrast therewith, in some embodiments of the present invention, the readers and/or energizing units can be left “on” all the time, there is no need to shut off to listen.

Transmission Options:
Purely Active Option: The bolus may transmit the stored data to a receiver at a frequency in the UHF range, for example 315 MHz or 434 MHz. Note that there is an ISO standard (ISO 18000-7) at 434 MHz but it is not related to animals. The ISO standards related to animals is only for passive at LF. Active boluses now on the market, which do not comply with ISO animal ID standards, are at 434 MHz.
To keep energy consumption low the bolus may not have a receiver and therefore may be designed to transmit “blindly” (on schedule), rather than in response to the presence of a reader providing an interrogating signal. Multiple redundant transmissions with a random time delay may be used to improve reception rate.
Optionally, the temperature (or other sensor) measurement and transmission may occur whenever adequate (a threshold amount of) energy has been collected (and stored) from the energy harvesting circuit to power the temperature measurement and transmission circuits, thereby reducing circuitry and energy consumption associated with storing the sensor data. And, unlike 2007/0279225, it is not necessary to shut down the energizing source (or unit).
These active transmission options may require that the bolus have an appropriate transmission range and that a sufficient number of receivers may be appropriately situated throughout a given area (such as on a dairy farm) such that it is highly probable that there always will be a receiver within reception range of a bolus transmission. In this approach there may be no way for the system to know that all transmissions from boluses are received. A list of known boluses may be maintained (at the system level), and this can be used to alert the “system” that some are not being received.) Therefore, highly redundant transmissions may be employed to ensure data is received even in the event of problems such as data collisions from multiple bolus transmissions; multipath interference and nulls; or radio interference. This redundancy may, for example, be 5 to 7 packets of data transmitted with random intervals between each packet. Of course, incorporating such redundancy in the bolus adds to the energy harvesting capacity needed.
Some problems being addressed here are common to 1-way beacon devices with no ability to send and ACK, sometimes referred to as “chirp tags”. Reliability depends on multiple, redundant transmissions and a very low duty cycle by any individual device, such as on the order of 0.1% or less.

Passive Tag in Bolus: The bolus does not contain an active radio. Instead, the inductive coupling between the bolus and the Energizing Unit also serves to provide RFID communication from the bolus. Whenever the ruminant animal approaches receive-enabled Energizing Unit the bolus may use passive RFID communications techniques to transmit data back to the Energizing Unit, which may also contain the receive function of an RFID reader. This technique, sometimes called backscatter, consists of the bolus circuitry loading the bolus LC antenna circuit in response to the bolus data. This loading of the bolus LC circuit is detected in the Energizing Unit via the mutual inductive coupling with the LC circuit in the Energizing Unit.

Using read/write RFID techniques the Energizing Unit can also transmit data to the bolus. In other words, the energizing LF magnetic signal created by the LC circuit in the Energizing Unit may be amplitude modulated (by the energizing unit) with data and this data may be decoded by circuitry in the bolus IC chip (microcontroller 702).

Passive Option: The microcontroller may be programmed such that the backscatter signal it creates by loading the bolus antenna emulates a standard RFID tag protocol, for example, ISO 11784, ISO 11785 or ISO 14223. This method may enable ID information in the boluses to be read with standardized animal RFID readers.

Battery Assisted Passive Option. In this option, in addition to enabling measurements to be taken and stored in memory, the stored energy can also be used to assist the passive communication and increase the range between the bolus and reader (a technique known in the RFID industry as “battery assisted passive”).

Inquiry Signal initiated active transmission option: In this option, the active transmissions may be initiated only when the bolus receives an inquiry signal from a signal source (such as a Querying Unit or Inquiry Source). (For an example of a similar approach, see United States Patent Publication No. 20070279225, incorporated by reference herein.)

An example of an Inquiry Source is a standard low frequency RFID reader.

An example of an antenna and receiver in the bolus is a low frequency resonant tuned coil and passive RFID circuit.

Inquiry Sources may, for example, be located where animals congregate, such as the entry to milking parlors, water troughs and feed bunks. Receivers (such as readers) to receive the active bolus transmission can be integrated into the Inquiry Sources, thereby essentially guaranteeing that an inquiry source receiver is in close proximity whenever the active transmission from the bolus is initiated.

Since the tag harvests energy from the energizing unit(s), the inquiry source just needs to tell the bolus to transmit. The inquiry source need not provide power for energy harvesting. The inquiry source need not perform all the functions of a reader. (Generally, one function of a reader is to provide power to passive tags.)

The Inquiry Sources can have their signal modulated and can thereby communicate data to the microcontroller in the bolus via the bolus receiving circuit. This communication link may allow the Inquiry Source to send acknowledgements (ACKs) of validly received bolus data which may then cause the existing (old) data stored in the bolus memory to be erased (thereby making room for new data). This communication link may also allow various operation parameters of the boluses to be configured in the field, for example the temperature sample interval.

The inquiry source may also comprise a receiver. When the inquiry source receiver receives data from the EH bolus, it knows that it is a communication with a specific ID and it could have instructions (from a higher entity in the system) to change the data/program in that specific bolus ID. This link may also allow the bolus to be written to with information such as an ear tag electronic or visual ID number.

### An Ear Tag Embodiment

A known type of active tag that operates at 434 MHz also has a low frequency (125 kHz) receiver built in. Reference is made to ISO/IEC18000-7, incorporated by reference herein. The purpose of this is to identify when the active tag is near a “marker loop”. The marker loop sends a 125 kHz query signal that is detected by the active tag causing it to transmit.

The way this system operates is that the active tag, for example on a car or on a cart in a factory, goes by a marker loop in the floor or road that is emitting the 125 kHz query signal. A receiver in the active tag hears this query and then causes the tag to transmit ID, data, etc. via its long range active transmitter.

Together with the query signal the marker loop sends its ID signal to the active tag and this ID is retransmitted with the active tag data. Therefore an active receiver (compare 230) receiving the tag transmission knows where the tag was when it transmitted (it knows it was near the marker loop with that ID).

According to this embodiment of the invention, the OBM (cow) may have an active external unit (ear tag or neck tag) based on this active/marker loop concept. The internal bolus would perform the function of the marker loop and would transmit a 125 kHz query signal to the ear tag, in this case data with temperature (and tag ID) data. The ear tag unit would then serve as a long range repeater of the bolus information. Alternatively, fixed receivers could be employed in addition to, or instead of, ear tags.

The active external ear tag transceiver may be provided on the animal, in close proximity to the energy harvesting (EH) bolus, to receive data from the bolus, including ID, temperature or other sensor data.

A transmitter in the bolus and a receiver in the ear tag may operate at a low frequency, such as 125 kHz, in the near field zone. It is essentially a low frequency active system in that it is not powered by energy from a reader.

This would enable a combination temperature and tracking capability, where the ear tag could have standard RFID, visual ID and real time location capability.

The external ear tag or neck tag transceiver may comprise an active transmitter that could serve as a relay of the bolus temperature data to a remote receiver. In this embodiment, the ear tag may have a battery that both powers a receiver that receives the bolus data (at LF) and a transmitter that transmits ear tag data, and the data received from the bolus, at UHF.

While the invention has been described with respect to a limited number of embodiments, these should not be construed as limitations on the scope of the invention, but rather as examples of some of the embodiments. Those skilled in the art may envision other possible variations, modifications, and implementations that are also within the scope of the invention, based on the disclosure(s) set forth herein.

What is claimed is:

1. Energy harvesting RFID tag comprising:
an RFID tag;
an energy harvesting (EH) device selected from the group consisting of mechanical-to-electrical (M2E) and radio frequency (RF); and
means for storing electrical energy harvested from the EH device.

2. The energy harvesting RFID tag of claim 1, wherein:
the means for storing energy is selected from the group consisting of capacitor, supercap and non-chemical battery

3. The energy harvesting RFID tag of claim 1, wherein:
the EH device converts mechanical energy to electrical energy.

4. The energy harvesting RFID tag of claim 1, wherein:
the EH device comprises a piezoelectric element.

5. The energy harvesting RFID tag of claim 1, wherein:
the RFID tag comprises an active transmitter (radio).

6. The energy harvesting RFID tag of claim 1, wherein:
the RFID tag comprises a passive RFID tag that communicates with an external RFID reader via backscatter.

7. The energy harvesting RFID tag of claim 1, wherein:
the RFID tag is packaged to fit in a bolus for a ruminant animal.

8. The energy harvesting RFID tag of claim 1, further comprising:
a magnet for preventing hardware disease packaged in the bolus.

9. The energy harvesting RFID tag of claim 1, further comprising:
a temperature sensor.

10. The energy harvesting RFID tag of claim 1, further comprising:
means for detecting a query signal which causes the RFID tag to transmit.

11. An RFID system comprising:
at least one RFID tag of the type set forth in claim 1; and
external devices selected from the group consisting of an RFID reader for interrogating the RFID tag, Energizing Units for supplying electromagnetic (RF) energy to be harvested by the RFID tag, Inquiry Sources (Querying units) for waking up the RFID tag, and Receivers for receiving data from the RFID tag.

12. The RFID system of claim 11, further comprising:
system supervisory devices may be provided for controlling the operation of the external devices and for monitoring and managing data collected from the RFID tags,

13. A method of operating an RFID tag comprising:
providing an energy harvesting (EH) device and storing electrical energy harvested from the EH device;
periodically measuring a condition and storing information related to the condition in the RFID tag;
periodically transmitting the information to a reader.

14. The method of claim 13, wherein:
the RFID tag transmits on a fixed interval.

15. The method of claim 13, wherein:
the RFID tag transmits when queried.

16. The method of claim 13, wherein:
the RFID tag transmits by communicating with an external reader using an active transmitter (radio).

17. The method of claim 13, wherein:
the RFID tag transmits by communicating with an external reader using a passive RFID protocol.

18. The method of claim 13, wherein:
the RFID tag can run off its stored energy and make several periodic measurements in an interim time between the periodic transmissions of data.

19. The method of claim 18, wherein:
measurements are made approximately once per hour; and
transmissions occur approximately a few times per day.

20. A method of monitoring a condition of a ruminant animal comprising:
harvesting energy from motion of the ruminant animal's rumen to power an RFID bolus disposed within the rumen.

21. The method of claim 20, wherein:
the condition comprises core temperature.

22. The method of claim 20, wherein:
the RFID bolus functions as a marker loop and transmits data to an external unit; and
the external unit serves as a long range repeater for the data.
